(19) United States
(12) Patent Application Publication
(10) Pub. No.: US 2013/0204408 A1
(43) Pub. Date: Aug. 8, 2013

(54) SYSTEM FOR CONTROLLING HOME AUTOMATION SYSTEM USING BODY MOVEMENTS

(71) Applicants: Hari Thiruvengada, Plymouth, MN (US); Jason Laberge, New Brighton, MN (US); Wendy Foslien, Woodbury, MN (US); Paul Derby, Lubbock, TX (US); Sriharsha Putrevu, Maple Grove, MN (US); Joseph Vargas, Morristown, NJ (US)

(72) Inventors: Hari Thiruvengada, Plymouth, MN (US); Jason Laberge, New Brighton, MN (US); Wendy Foslien, Woodbury, MN (US); Paul Derby, Lubbock, TX (US); Sriharsha Putrevu, Maple Grove, MN (US); Joseph Vargas, Morristown, NJ (US)

(73) Assignee: Honeywell International Inc., Morristown, NJ (US)

(21) Appl. No.: 13/367,015

(22) Filed: Feb. 6, 2012

(51) Int. Cl. G06F 17/00

(52) U.S. Cl. 700/90

(57) ABSTRACT

A home automation system includes data relating to three dimensional body movements. The system receives a signal generated by a sensing of a three dimensional body movement of a person, compares the signal relating to the three dimensional body movement of the person to the stored data relating to the three dimensional body movements, identify the body movement of the person based on the comparison; and control a home automation system as a function of the identified body movement.

### TECHNICAL FIELD

The present disclosure relates to a system for controlling a home automation system using body movements of a person.

### BACKGROUND

People of course are adept at manifest control using naturalistic physical gestures. For instance, people constantly interact with objects (e.g. a coffee cup) within their environment using physical gestures (such as picking it up holding it close to his or her mouth, titling the cup to sip coffee, etc.). Now however, in addition to such manifest control, with the advent of commercial body movement and gesture-based game consoles such as Kinect, Playstation3, and Wii, body movement and gesture-based interaction has become more pervasive and ubiquitous in residential environments.

### BRIEF DESCRIPTION OF THE DRAWINGS

FIGS. 1A and 1B are a diagram of features of a system that uses body movements of a person to control a home automation system.

FIG. 2 is a block diagram of a home automation system that can be controlled by body movements.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, electrical, and optical changes may be made without departing from the scope of the present invention. The following description of example embodiments is, therefore, not to be taken in a limited sense, and the scope of the present invention is defined by the appended claims.

Currently, home automation and/or control systems such as home thermostats or security cameras require humans to touch them or use a keyboard and mouse in order to interact with them. Additionally, these devices require the user to interact from a fixed position in front of a display or device, such as a computer monitor, small touch screen, or thermostat. An embodiment implements an approach to control home automation systems using metaphoric gestures and/or body movements that do not require a person to touch the devices in order to interact with them. Instead, the person interacts by simply mimicking metaphoric gestures and/or other body movements that are easily and readily recognized and translated to control outcomes. A combination of 3-dimensional gestures and/or body movements (including physical body movements such as a head movement, a shoulder movement, an arm movement, a hand movement, a finger movement, a leg movement, a foot movement, a hip movement, a waist movement, and a torso movement; and other body movements such as an eye movement and a mouth movement; and a sensing of a voice) can be used to interact with home automation systems.

Consequently, metaphoric gestures and other body movements offer a means to represent naturalistic physical gestures to which humans are accustomed. Metamorphic gestures and other body movements are different from touch screen display gestures because the gestures and body movements are done by a person in 3-dimensional space (x, y and z), and the gestures and body movements do not involve a person contacting the device that the person is trying to control or adjust. Metaphoric gestures and body movements occur when the movements of the person are similar to the intended interaction with the home automation system. Examples of metaphoric gestures and other such body movements would be tracing a circle to simulate “rotation” or lifting one's legs to simulate “walking” (i.e., physical body gestures). Another example of a metaphoric gesture could be movement of the eyes to manipulate a cursor or interact with elements on a display. Voice commands or mouth movements to communicate intended actions (e.g., “Yes/No” to indicate acceptance or rejection) could also be used.

An embodiment is different from existing systems and other prior art in several ways. First, users can interact with the system from a variety of locations that do not require the users to stand directly in front of a device or display. Second, metaphoric gestures and other body movements are used to quickly and intuitively interact with the system, which allows the user to interact from greater distances while simultaneously doing other tasks. This feature can be referred to as any-time, any-where, and any-how interaction. In contrast, current systems typically require users to interact with a mouse, a keyboard, a button, a switch, and/or a small surface enabled touch screen display. Third, current systems do not support eye or mouth movements, but eye or mouth movements are a type of gesture that can be used to interact with the system.

In one or more embodiments, a person can interact with the system from a variety of locations, including mobile devices that support gesture and other body movement recognition. There can be pre-defined interaction ‘zones’ in a residence in which the user can complete gestures to interact with the system. The interaction zones will typically be proximate to system displays. Alternatively, an entire home could become ‘gesture enabled’ whereby each room has a gesture or body movement sensor (similar to Microsoft Kinect). Furthermore, in some instances at least, no display is required. Lastly, smart devices could have built-in gesture recognition capabilities that support metaphoric gesture interaction and other body movements with the system.

As noted above, novel and intuitive metaphoric gestures can be used to support user interaction with the system. Eye movements can be used to extend the traditional definition of ‘gestures’ and body movement beyond hand, arm, leg, and head movements, and include movement of the eyes (including blinks). Mouth movements can also be used to extend the traditional definition of ‘gestures’ and body movement and could include verbal commands, utterances, or movement of the lips. The display used to support the interaction could be any in-home display capable of interfacing to the home automation system. This could be a personal computer, television, smart appliance, portable phone, hand-held device, a body-attachable device, or other device. Feedback can be provided via the displays and can indicate that users are interacting with the system correctly (or incorrectly).

Computer processors, such as those embedded in gaming consoles like Microsoft Kinect, Nintendo Wii, and Sony Playstation3 can be coupled to an infrared camera, a three dimensional (3D) depth sensing camera, a voice recognition system, an accelerometer, and face recognition module, one or more of which can sense whether there is a mobile object within its current environment. In an embodiment, these sensors are combined to detect whether an intrusion has occurred in the home and automatically updates the home automation system. The home automation system notifies the home owner, resident, and/or authorities when an intrusion has occurred based on the sensory inputs and the decision logic. If there is an intrusion, the system captures video pictures and sends an alert to a home owner to see if the authorities need to be notified. The system can also update information on a website and/or a hand held device, and provide periodic updates about the status of the home directly without the need for an expensive security system within the home.

An embodiment includes a technology that would combine these sensors to detect whether the home is currently occupied and automatically update the home automation system. The home automation system would take the appropriate measures to control the comfort of the home based on the sensory inputs and the decision logic. If the home is occupied, then the system notifies the HVAC system and thermostat to adjust the home comfort based on a user's preference. The home automation can easily toggle the settings between “HOME” and “AWAY” modes based on the occupancy detection. The Wi-Fi activity and profile of a networked game console, when in use, can also provide an indication of the occupancy of the home. It can also update information on a website, an iPhone, or other device, and provide periodic updates about the status of the home directly without the need for an expensive occupancy detection system within the home.

Metaphoric gesture-based control of a home automation system using multimodal metaphoric gestures and other body movements can include several embodiments. First, the system can use pure metaphoric 3D gestures, 3D gestures in combination with voice recognition, and/or a virtual keyboard in combination with 3D gestures. Second, a gaming console that recognizes such 3D gestures can be used to control an entire home. Third, any in-home display can be controlled.

The gestures can indicate an intent to interact with the system. This can be done in a variety of ways including standing in an interaction zone, raising an arm, and/or uttering a verbal command.

The gestures can indicate a selection of a home automation function to use. For example, point and grasp gestures can be used to move a cursor on the display, verbal commands can be used to select a function, eye movements can be used to move a cursor, and blinking can indicate a selection.

The gestures can be used to navigate user screens. For example, point and grasp gestures can be used to move a cursor and select different navigation options/buttons. Eye movements and verbal commands can also be used.

The gestures can be used to enter numerical values for the home automation functions, for example, a numerical setting on a thermostat. This can include entering a numerical value if not already entered, and incrementing or decrementing a numerical value. This can be implemented in several ways. A user can draw numbers in the air, and the system accepts this as a numeric input. The user can verbally utter the numbers he or she wants to enter. The user can also accept/verify the numeric input using a ‘check’ gesture, blink, verbal utterance, or mouth movement. The system can also be configured to recognize a user sliding the back of his or her hand across the forehead to indicate that the room is too warm and the thermostat should be turned down. The system can also be configured to recognize a user folding his or her arms across the front of the body, indicating that the room is too cold and that the thermostat should be turned up. The system can also be configured to recognize a thumb up to increase, and a thumb down to decrease. Moving the hand upward (back and forth) or moving the hand downward (back and forth) can alter the rate of increase or decrease.

The gestures and other body movements can also be used to accomplish a zooming in or a zooming out on a display screen. A user can complete zoom interactions in a variety of ways. For example, the zoom function is used in a number of situations including zooming a floor plan map of a home, zooming in to an energy usage trend, and zooming a camera in/out. The actual implementation of the zooming can be accomplished by holding two hands up with the index finger and thumb from each hand forming a ‘frame’, and then making the frame larger or smaller by moving the hands away (zoom out) or together (zoom in). Mouth movements or verbal utterances could also be used to zoom in and zoom out. The zoom in and zoom out function can also be invoked by holding both hands out front with fingers crossed and either moving away from the user (zoom in) or moving it towards the user (zoom out). A binocular gesture could also be used, wherein a user holds up his or her hands to their eyes like in holding a set of binoculars, and step forward to zoom in and step backward to zoom out.

The gestures and body movements can also be used to select a device such as a camera, a lighting device, and an appliance with which to interact. For example, a user can position one hand over the display unit work space and use the other hand to make circles around the objects they want to select. Alternatively, a user can use eye movements to move a cursor over the objects, and then a blinking of the eye can be used to make a selection of a device or appliance. Verbal utterances could also be used to select a device.

The gestures can also be used to power a device on or off. Once selected, a user can make object-specific gestures and/or body movements to power devices on or off. For examples, once selected, a single finger flip up/down could be used to turn lights on or off. A single hand rotary motion could be used to turn an oven on or off.

The gestures and body movements can also be used to control a security system such as the manipulation of security cameras. Security cameras are a specific aspect of a home automation system with which the user can interact. Once a camera is selected, it can be individually or collectively manipulated. For example, a camera can be panned left or right by holding one hand up with palm toward the display and moving the other hand toward the fixed hand either to the right or to the left. A camera can be tilted by holding one hand up with palm toward the display and tilting a second hand forward or back with the palm toward the display. A camera can be zoomed in or zoomed out using the zoom gestures described above. A camera can be panned and tilted using eye movements to move a camera cursor on the live camera view to another part of the visible camera range. A blink can be used to indicate that the user is finished moving the camera. While a camera is manipulated, a user can get instant feedback in the display via a live camera view.

The system can also be used to automatically indicate occupancy of an interaction “zone” and adjust the home automation system accordingly. For example, if the system detects several people in a zone, the system could send a signal to the HVAC system for more cooling to compensate.

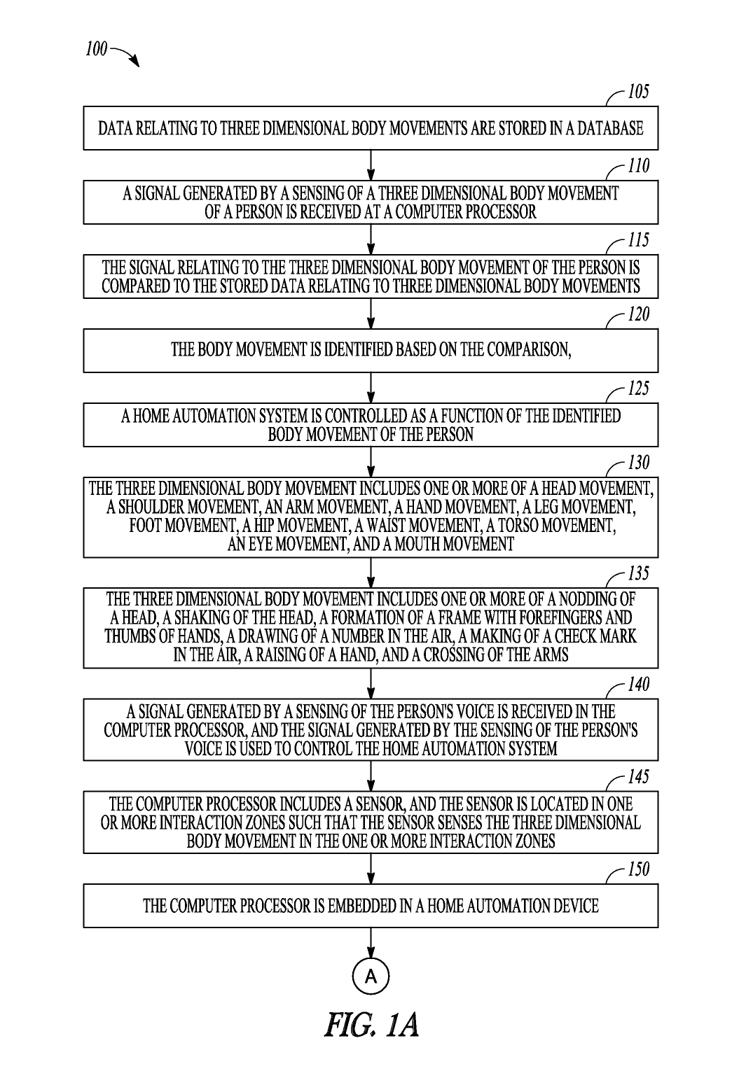

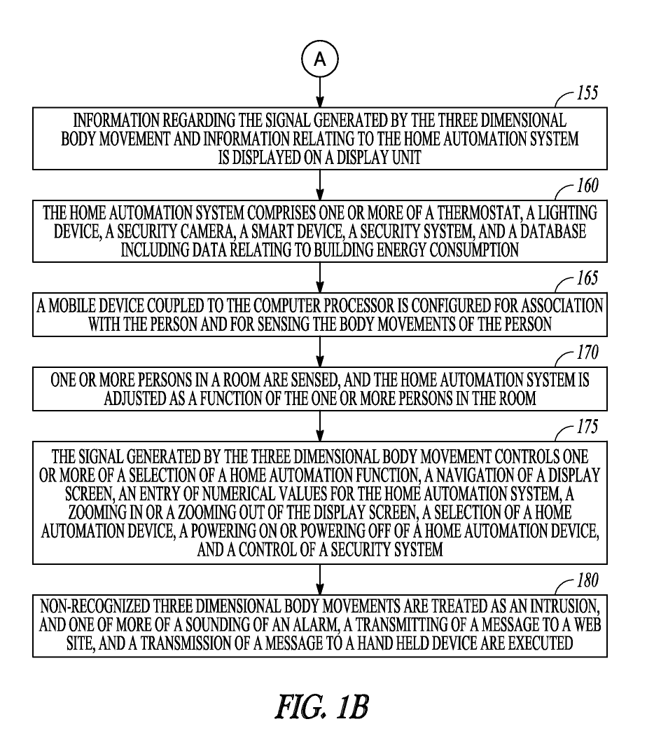

FIGS. 1A and 1B are a diagram of features of a system for using gestures and other body movements to control a home automation system. FIGS. 1A and 1B includes a number of blocks 105-180. Though arranged serially in a flowchart-like format in the example of FIGS. 1A and 1B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIGS. 1A and 1B, at 105, data relating to three dimensional body movements are stored in a database. At 110, a signal generated by a sensing of a three dimensional body movement of a person is received at a computer processor. At 115, the signal relating to the three dimensional body movement of the person is compared to the stored data relating to three dimensional body movements. At 120, the body movement is identified based on the comparison, and at 125, a home automation system is controlled as a function of the identified body movement of the person.

At 130, the three dimensional body movement includes one or more of a head movement, a shoulder movement, an arm movement, a hand movement, a leg movement, a foot movement, a hip movement, a waist movement, a torso movement, an eye movement, and a mouth movement. At 135, the three dimensional body movement includes one or more of a nodding of a head, a shaking of the head, a formation of a frame with forefingers and thumbs of hands, a drawing of a number in the air, a making of a check mark in the air, a raising of a hand, and a crossing of the arms.

At 140, a signal generated by a sensing of the person's voice is received in the computer processor, and the signal generated by the sensing of the person's voice is used to control the home automation system. At 145, the computer processor includes a sensor, and the sensor is located in one or more interaction zones such that the sensor senses the three dimensional body movement in the one or more interaction zones. At 150, the computer processor is embedded in a home automation device. At 155, information regarding the signal generated by the three dimensional body movement and information relating to the home automation system is displayed on a display unit. At 160, the home automation system comprises one or more of a thermostat, a lighting device, a security camera, a smart device, a security system, and a database including data relating to building energy consumption. The smart device can be configured to control a window shade, a swimming pool pump and temperature settings, and refrigerator settings, just to list a few applications. The security system can include control of alarm settings.

At 165, a mobile device coupled to the computer processor is configured for association with the person and for sensing the body movements of the person. At 170, one or more persons in a room are sensed, and the home automation system is adjusted as a function of the one or more persons in the room. The devices that can be adjusted can relate to temperature, lighting, music, and television, just to list a few of such devices. At 175, the signal generated by the three dimensional body movement controls one or more of a selection of a home automation function, a navigation of a display screen, an entry of numerical values for the home automation system, a zooming in or a zooming out of the display screen, a selection of a home automation device, a powering on or powering off of a home automation device, and a control of a security system. At 180, non-recognized three dimensional body movements are treated as an intrusion, and one of more of a sounding of an alarm, a transmitting of a message to a web site, and a transmission of a message to a hand held device are executed.

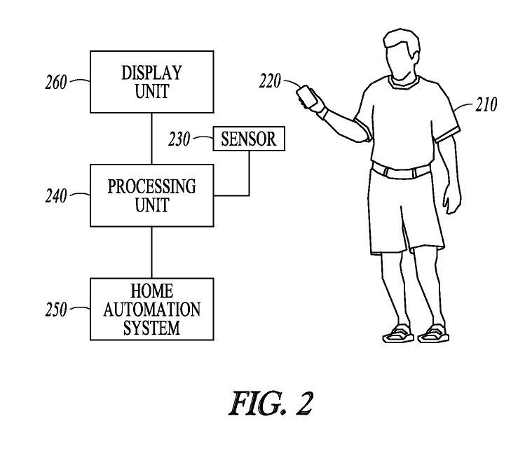

FIG. 2 is a block diagram of a home automation system that can be controlled by body movements. Specifically, FIG. 2 illustrates a person 210, who may have a transmitter 220 attached to a portion of his or her body. The transmitter 220 may also be hand held. In another embodiment, a transmitter 220 is not required. A sensor 230 wirelessly senses the body movements of the person 210, and generates a signal that is transmitted to a processing unit 240. The processing unit 240 is coupled to a home automation system 250, and a display unit 260.

### Example Embodiments

Several embodiments and sub-embodiments have been disclosed above, and it is envisioned that any embodiment can be combined with any other embodiment or sub-embodiment. Specific examples of such combinations are illustrated in the examples below.

Example No. 1 is a system including one or more of a computer processor and a computer storage device that are configured to store data relating to three dimensional body movements; receive a signal generated by a sensing of a three dimensional body movement of a person; compare the signal relating to the three dimensional body movement of the person to the stored data relating to three dimensional body movements; identify the body movement based on the comparison; and control a home automation system as a function of the identified body movement of the person.

Example No. 2 includes the features of Example No. 1 and optionally includes a system wherein the three dimensional body movement comprises one or more of a head movement, a shoulder movement, an arm movement, a hand movement, a finger movement, a leg movement, a foot movement, a hip movement, a waist movement, a torso movement, an eye movement, and a mouth movement.

Example No. 3 includes the features of Example Nos. 1-2 and optionally includes a system wherein the three dimensional body movement comprises one or more of a nodding of a head, a shaking of the head, a formation of a frame with forefingers and thumbs of hands, a drawing of a number in the air, a making of a check mark in the air, a raising of a hand, and a crossing of the arms.

Example No. 4 includes the features of Example Nos. 1-3 and optionally includes a system wherein the computer processor is configured to receive a signal generated by a sensing of the person's voice, and to use the signal generated by the sensing of the person's voice to control the home automation system.

Example No. 5 includes the features of Example Nos. 1-4 and optionally includes a system wherein the computer processor comprises a sensor, and the sensor is located in one or more interaction zones such that the sensor senses the three dimensional body movement in the one or more interaction zones.

Example No. 6 includes the features of Example Nos. 1-5 and optionally includes a system wherein the computer processor is embedded in a home automation device.

Example No. 7 includes the features of Example Nos. 1-6 and optionally includes a system comprising a display unit coupled to the computer processor, the display unit configured to display information regarding the signal generated by the three dimensional body movement and information relating to the home automation system.

Example No. 8 includes the features of Example Nos. 1-7 and optionally includes a home automation system including one or more of a thermostat, a lighting device, a security camera, a smart device, a security system, and a database of building energy consumption data.

Example No. 9 includes the features of Example Nos. 1-8 and optionally includes a system including a mobile device coupled to the computer processor, the mobile device configured for association with the person and for sensing the body movements of the person.

Example No. 10 includes the features of Example Nos. 1-9 and optionally includes a system wherein the computer processor is configured to sense one or more persons in a room, and to adjust the home automation system as a function of the one or more persons in the room.

Example No. 11 includes the features of Example Nos. 1-10 and optionally includes a system wherein the signal generated by the three dimensional body movement controls one or more of a selection of a home automation function, a navigation of a display screen, an entry of numerical values for the home automation system, a zooming in or a zooming out of the display screen, a selection of a home automation device, a powering on or powering off of a home automation device, and a control of a security system.

Example No. 12 includes the features of Example Nos. 1-11 and optionally includes a system wherein the computer processor is configured to treat non-recognized three dimensional body movements as an intrusion, and to execute one of more of a sounding of an alarm, a transmitting of a message to a web site, and a transmission of a message to a hand held device.

Example No. 13 is a computer readable storage device comprising instructions that when executed by a processor execute a process comprising storing data relating to three dimensional body movements; receiving a signal generated by a sensing of a three dimensional body movement of a person; comparing the signal relating to the three dimensional body movement of the person to the stored data relating to three dimensional body movements; identifying the body movement based on the comparison; and controlling a home automation system as a function of the identified body movement of the person.

Example No. 14 includes the features of Example No. 13 and optionally includes a computer readable storage device including instructions for receiving a signal generated by a sensing of the person's voice, and instructions for using the signal generated by the sensing of the person's voice to control the home automation system.

Example No. 15 includes the features of Example Nos. 13-14 and optionally includes a computer readable storage device including instructions to display information regarding the signal generated by the three dimensional body movement and information relating to the home automation system.

Example No. 16 includes the features of Example Nos. 13-15 and optionally includes a computer readable storage device including instructions for sensing one or more persons in a room, and instructions for adjusting the home automation system as a function of the one or more persons in the room.

Example No. 17 includes the features of Example Nos. 13-16 and optionally includes a computer readable storage device including instructions for controlling one or more of a selection of a home automation function, a navigation of a display screen, an entry of numerical values for the home automation system, a zooming in or a zooming out of the display screen, a selection of a home automation device, a powering on or powering off of a home automation device, and a control of a security system.

Example No. 18 includes the features of Example Nos. 13-17 and optionally includes a computer readable storage device including instructions for treating non-recognized three dimensional body movements as an intrusion, and instructions for executing one of more of a sounding of an alarm, a transmitting of a message to a web site, and a transmission of a message to a hand held device.

Example No. 19 is a process including storing in a computer readable storage device data relating to three dimensional body movements; receiving in a computer processor a signal generated by a sensing of a three dimensional body movement of a person; comparing with the computer processor the signal relating to the three dimensional body movement of the person to the stored data relating to three dimensional body movements; identifying with the computer processor the body movement based on the comparison; and controlling with the computer processor a home automation system as a function of the identified body movement of the person.

Example No. 20 includes the features of Example No. 19 and optionally includes controlling one or more of a selection of a home automation function, a navigation of a display screen, an entry of numerical values for the home automation system, a zooming in or a zooming out of the display screen, a selection of a home automation device, a powering on or powering off of a home automation device, and a control of a security system.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
one or more of a computer processor and a computer storage device configured to:
store data relating to three dimensional body movements;
receive a signal generated by a sensing of a three dimensional body movement of a person;
compare the signal relating to the three dimensional body movement of the person to the stored data relating to three dimensional body movements;
identify the body movement based on the comparison; and
control a home automation system as a function of the identified body movement of the person.

2. The system of claim 1, wherein the three dimensional body movement comprises one or more of a head movement, a shoulder movement, an arm movement, a hand movement, a finger movement, a leg movement, a foot movement, a hip movement, a waist movement, a torso movement, an eye movement, and a mouth movement.

3. The system of claim 2, wherein the three dimensional body movement comprises one or more of a nodding of a head, a shaking of the head, a formation of a frame with forefingers and thumbs of hands, a drawing of a number in the air, a making of a check mark in the air, a raising of a hand, and a crossing of the arms.

4. The system of claim 1, comprising a computer processor configured to receive a signal generated by a sensing of the person's voice, and using the signal generated by the sensing of the person's voice to control the home automation system.

5. The system of claim 1, wherein the computer processor comprises a sensor, and the sensor is located in one or more interaction zones such that the sensor senses the three dimensional body movement in the one or more interaction zones.

6. The system of claim 1, wherein the computer processor is embedded in a home automation device.

7. The system of claim 1, comprising a display unit coupled to the computer processor, the display unit configured to display information regarding the signal generated by the three dimensional body movement and information relating to the home automation system.

8. The system of claim 1, wherein the home automation system comprises one or more of a thermostat, a lighting device, a security camera, a smart device, a security system, and a database of building energy consumption data.

9. The system of claim 1, comprising a mobile device coupled to the computer processor, the mobile device configured for association with the person and for sensing the body movements of the person.

10. The system of claim 1, wherein the computer processor is configured to sense one or more persons in a room, and to adjust the home automation system as a function of the one or more persons in the room.

11. The system of claim 1, wherein the signal generated by the three dimensional body movement controls one or more of a selection of a home automation function, a navigation of a display screen, an entry of numerical values for the home automation system, a zooming in or a zooming out of the display screen, a selection of a home automation device, a powering on or powering off of a home automation device, and a control of a security system.

12. The system of claim 1, wherein the computer processor is configured to treat non-recognized three dimensional body movements as an intrusion, and to execute one of more of a sounding of an alarm, a transmitting of a message to a web site, and a transmission of a message to a hand held device.

13. A computer readable storage device comprising instructions that when executed by a processor execute a process comprising:
storing data relating to three dimensional body movements;
receiving a signal generated by a sensing of a three dimensional body movement of a person;
comparing the signal relating to the three dimensional body movement of the person to the stored data relating to three dimensional body movements;
identifying the body movement based on the comparison; and
controlling a home automation system as a function of the identified body movement of the person.

14. The computer readable storage device of claim 13, comprising instructions for receiving a signal generated by a sensing of the person's voice, and instructions for using the signal generated by the sensing of the person's voice to control the home automation system.

15. The computer readable storage device of claim 13, comprising instructions to display information regarding the signal generated by the three dimensional body movement and information relating to the home automation system.

16. The computer readable storage device of claim 13, comprising instructions for sensing one or more persons in a room, and instructions for adjusting the home automation system as a function of the one or more persons in the room.

17. The computer readable storage device of claim 13, comprising instructions for controlling one or more of a selection of a home automation function, a navigation of a display screen, an entry of numerical values for the home automation system, a zooming in or a zooming out of the display screen, a selection of a home automation device, a powering on or powering off of a home automation device, and a control of a security system.

18. The computer readable storage device of claim 13, comprising instructions for treating non-recognized three dimensional body movements as an intrusion, and instructions for executing one of more of a sounding of an alarm, a transmitting of a message to a web site, and a transmission of a message to a hand held device.

19. A process comprising:
storing in a computer readable storage device data relating to three dimensional body movements;
receiving in a computer processor a signal generated by a sensing of a three dimensional body movement of a person;
comparing with the computer processor the signal relating to the three dimensional body movement of the person to the stored data relating to three dimensional body movements;
identifying with the computer processor the body movement based on the comparison; and
controlling with the computer processor a home automation system as a function of the identified body movement of the person.

20. The process of claim 19, comprising controlling one or more of a selection of a home automation function, a navigation of a display screen, an entry of numerical values for the home automation system, a zooming in or a zooming out of the display screen, a selection of a home automation device, a powering on or powering off of a home automation device, and a control of a security system.
